(19) United States
(12) Patent Application Publication
(10) Pub. No.: US 2009/0204791 A1
(43) Pub. Date: Aug. 13, 2009

(54) Compound Instruction Group Formation and Execution

(76) Inventor: David A. Luick, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 12/029,830

(22) Filed: Feb. 12, 2008

(51) Int. Cl. G06F 9/312

(52) U.S. Cl. 712/207; 712/E09.033

(57) ABSTRACT

A method and apparatus for forming compound issue groups containing instructions from multiple cache lines of instructions are provided. By pre-fetching instruction lines containing instructions targeted by a conditional branch statement, if it is predicted that the conditional branch will be taken, a compound issue group may be formed with instructions from the I-line containing the branch statement and the I-line containing instructions targeted by the branch.

### BACKGROUND OF THE INVENTION

1. Field of the Invention

The present invention generally relates to the field of computer processors.

2. Description of the Related Art

In state of the art processors, a set of instructions may be issued as a group to a pipelined execution unit that operates on the instructions in parallel. Challenges are presented, however, when conditional branch instructions target instructions outside a current instruction line (I-line). In an effort to continue processing before the condition can be resolved, conventional pipelined machines may predict that the branch will not be taken and continue sequential execution along the “not-taken” instruction path.

Unfortunately, if the condition is met and the branch is taken these processing cycles are wasted and the I-line containing the targeted instruction is fetched. This is particularly troubling if the conditional branches are predictable, for example, based on past execution history (e.g., indicating the branch is often taken).

### SUMMARY OF THE INVENTION

One embodiment provides a method of forming a compound issue group of instructions. The method generally includes fetching a first instruction line from a level 2 cache, the first instruction line having a branch instruction targeting an instruction that is outside of the first instruction line, prefetching, from the level 2 cache, a second instruction line containing the targeted instruction, forming a compound issue group containing a sequential stream of instructions including instructions from the first instruction line prior to the branch instruction and at least the targeted instruction from the second instruction line, and issuing the compound issue group to a pipelined execution unit for execution.

One embodiment provides a processor generally including a level 2 cache, a level 1 cache configured to receive instruction lines from the level 2 cache, wherein each instruction line comprises one or more instructions, a processor core configured to execute instructions retrieved from the level 1 cache, and scheduling circuitry. The scheduling circuitry is generally configured to fetch a first instruction line from a level 2 cache, the first instruction line having a branch instruction targeting an instruction that is outside of the first instruction line, prefetch a second instruction line containing the targeted instruction from the level 2 cache, form a compound issue group containing a sequential stream of instructions including instructions from the first instruction line prior to the branch instruction and at least the targeted instruction from the second instruction line, and issue the compound issue group to a pipelined execution unit for execution.

One embodiment provides an integrated circuit generally including a cascaded delayed execution unit and scheduling circuitry. The cascaded delayed execution pipeline unit generally includes at least first and second execution pipelines, wherein instructions in a common issue group issued to the execution pipeline unit are executed in the first execution pipeline before the second execution pipeline. The scheduling circuitry is generally configured to prefetch first and second cache lines of instructions, form an issue group having a sequential stream of one or more instructions in the first cache line before a branch instruction and one or more instructions in the second cache line targeted by the branch instruction, determine if a second instruction in the issue group is dependent on results generated by executing a first instruction in the issue group and, if so, schedule the first instruction for execution in the first execution pipeline and schedule the second instruction for execution in the second execution pipeline.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram depicting a system according to one embodiment of the invention.

FIG. 2 is a block diagram depicting a computer processor according to one embodiment of the invention.

FIG. 3 is a block diagram depicting one of the cores of the processor according to one embodiment of the invention.

FIGS. 4A and 4B compare the performance of conventional pipeline units to pipeline units in accordance with embodiments of the present invention.

FIG. 5 illustrates an exemplary integer cascaded delayed execution pipeline unit in accordance with embodiments of the present invention.

FIG. 6 is a flow diagram of exemplary operations for scheduling and issuing instructions in accordance with embodiments of the present invention.

FIGS. 7A-7D illustrate the flow of instructions through the pipeline unit shown in FIG. 5.

FIG. 8 is a detailed block diagram of scheduling circuitry in accordance with embodiments of the present invention.

FIG. 9 illustrates an example compound issue group.

### DETAILED DESCRIPTION OF THE PREFERRED EMBODIMENTS

The present invention generally provides an improved technique for executing instructions in a pipelined manner that may reduce stalls that occur when executing dependent instructions. Stalls may be reduced by utilizing a cascaded arrangement of pipelines with execution units that are delayed with respect to each other. This cascaded delayed arrangement allows dependent instructions to be issued within a common issue group by scheduling them for execution in different pipelines to execute at different times.

As an example, a first instructions may be scheduled to execute on a first “earlier” or “less-delayed” pipeline, while a second instruction (dependent on the results obtained by executing the first instruction) may be scheduled to execute on a second “later” or “more-delayed” pipeline. By scheduling the second instruction to execute in a pipeline that is delayed relative to the first pipeline, the results of the first instruction may be available just in time when the second instruction is to execute. While execution of the second instruction is still delayed until the results of the first instruction are available, subsequent issue groups may enter the cascaded pipeline on the next cycle, thereby increasing throughput. In other words, such delay is only “seen” on a first issue group and is “hidden” for subsequent issue groups, allowing a different issue group (even with dependent instructions) to be issued each pipeline cycle.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

The following is a detailed description of embodiments of the invention depicted in the accompanying drawings. The embodiments are examples and are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims.

Embodiments of the invention may be utilized with and are described below with respect to a system, e.g., a computer system. As used herein, a system may include any system utilizing a processor and a cache memory, including a personal computer, internet appliance, digital media appliance, portable digital assistant (PDA), portable music/video player and video game console. While cache memories may be located on the same die as the processor which utilizes the cache memory, in some cases, the processor and cache memories may be located on different dies (e.g., separate chips within separate modules or separate chips within a single module).

### Overview of an Exemplary System

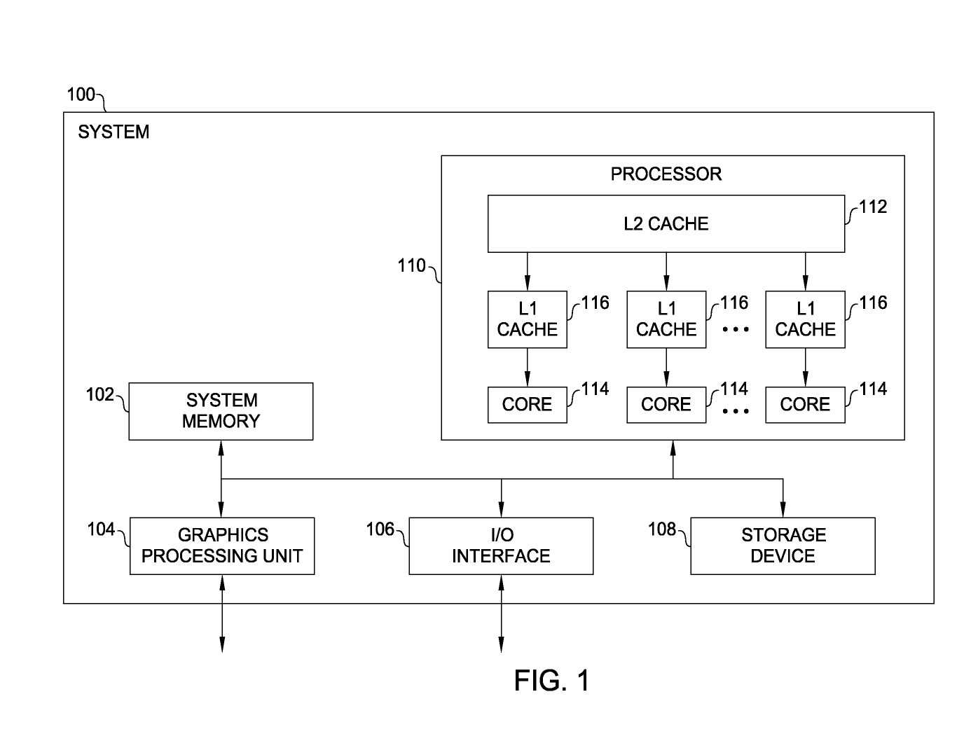

FIG. 1 is a block diagram depicting a system 100 according to one embodiment of the invention. The system 100 may contain a system memory 102 for storing instructions and data, a graphics processing unit 104 for graphics processing, an I/O interface for communicating with external devices, a storage device 108 for long term storage of instructions and data, and a processor 110 for processing instructions and data.

According to one embodiment of the invention, the processor 110 may have an L2 cache 112 as well as multiple L1 caches 116, with each L1 cache 116 being utilized by one of multiple processor cores 114. According to one embodiment, each processor core 114 may be pipelined, wherein each instruction is performed in a series of small steps with each step being performed by a different pipeline stage.

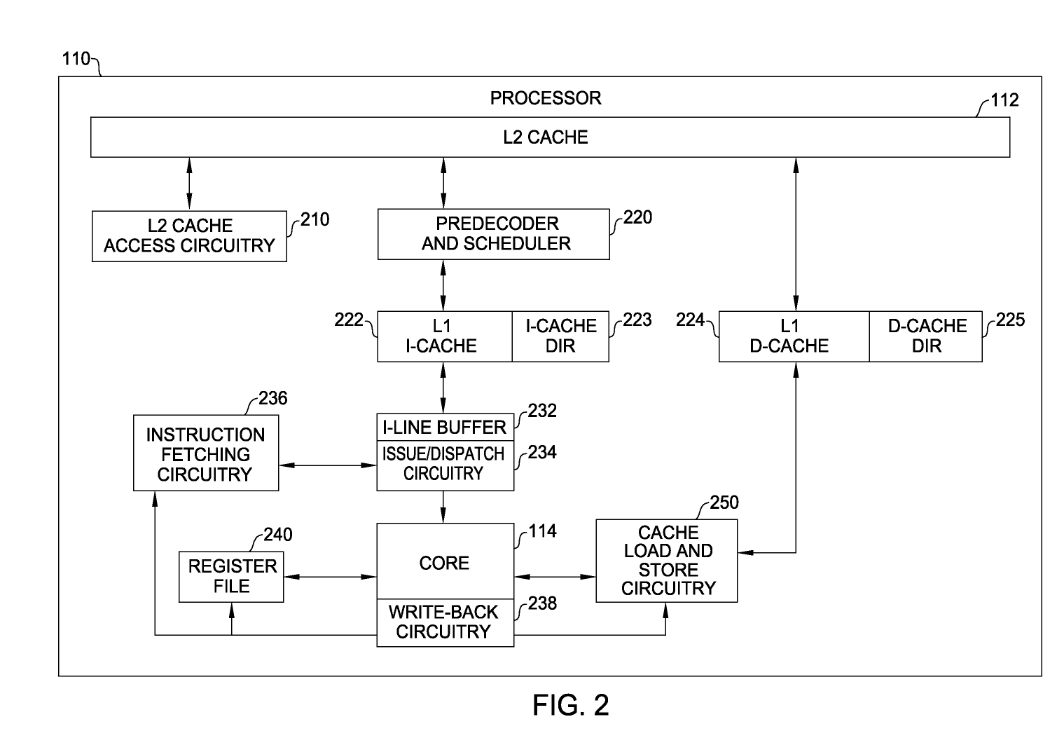

FIG. 2 is a block diagram depicting a processor 110 according to one embodiment of the invention. For simplicity, FIG. 2 depicts and is described with respect to a single core 114 of the processor 110. In one embodiment, each core 114 may be identical (e.g., containing identical pipelines with the same arrangement of pipeline stages). For other embodiments, cores 114 may be different (e.g., containing different pipelines with different arrangements of pipeline stages).

In one embodiment of the invention, the L2 cache may contain a portion of the instructions and data being used by the processor 110. In some cases, the processor 110 may request instructions and data which are not contained in the L2 cache 112. Where requested instructions and data are not contained in the L2 cache 112, the requested instructions and data may be retrieved (either from a higher level cache or system memory 102) and placed in the L2 cache. When the processor core 114 requests instructions from the L2 cache 112, the instructions may be first processed by a predecoder and scheduler 220.

In one embodiment of the invention, instructions may be fetched from the L2 cache 112 in groups, referred to as I-lines. Similarly, data may be fetched from the L2 cache 112 in groups referred to as D-lines. The L1 cache 116 depicted in FIG. 1 may be divided into two parts, an L1 instruction cache 222 (I-cache 222) for storing I-lines as well as an L1 data cache 224 (D-cache 224) for storing D-lines. I-lines and D-lines may be fetched from the L2 cache 112 using L2 access circuitry 210.

In one embodiment of the invention, I-lines retrieved from the L2 cache 112 may be processed by a predecoder and scheduler 220 and the I-lines may be placed in the I-cache 222. To further improve processor performance, instructions are often predecoded, for example, I-lines are retrieved from L2 (or higher) cache. Such predecoding may include various functions, such as address generation, branch prediction, and scheduling (determining an order in which the instructions should be issued), which is captured as dispatch information (a set of flags) that control instruction execution. For some embodiments, the predecoder (and scheduler) 220 may be shared among multiple cores 114 and L1 caches.

In addition to receiving instructions from the issue and dispatch circuitry 234, the core 114 may receive data from a variety of locations. Where the core 114 requires data from a data register, a register file 240 may be used to obtain data. Where the core 114 requires data from a memory location, cache load and store circuitry 250 may be used to load data from the D-cache 224. Where such a load is performed, a request for the required data may be issued to the D-cache 224. At the same time, the D-cache directory 225 may be checked to determine whether the desired data is located in the D-cache 224. Where the D-cache 224 contains the desired data, the D-cache directory 225 may indicate that the D-cache 224 contains the desired data and the D-cache access may be completed at some time afterwards. Where the D-cache 224 does not contain the desired data, the D-cache directory 225 may indicate that the D-cache 224 does not contain the desired data. Because the D-cache directory 225 may be accessed more quickly than the D-cache 224, a request for the desired data may be issued to the L2 cache 112 (e.g., using the L2 access circuitry 210) after the D-cache directory 225 is accessed but before the D-cache access is completed.

In some cases, data may be modified in the core 114. Modified data may be written to the register file, or stored in memory. Write back circuitry 238 may be used to write data back to the register file 240. In some cases, the write back circuitry 238 may utilize the cache load and store circuitry 250 to write data back to the D-cache 224. Optionally, the core 114 may access the cache load and store circuitry 250 directly to perform stores. In some cases, as described below, the write-back circuitry 238 may also be used to write instructions back to the I-cache 222.

As described above, the issue and dispatch circuitry 234 may be used to form instruction groups and issue the formed instruction groups to the core 114. The issue and dispatch circuitry 234 may also include circuitry to rotate and merge instructions in the I-line and thereby form an appropriate instruction group. Formation of issue groups may take into account several considerations, such as dependencies between the instructions in an issue group as well as optimizations which may be achieved from the ordering of instructions as described in greater detail below. Once an issue group is formed, the issue group may be dispatched in parallel to the processor core 114. In some cases, an instruction group may contain one instruction for each pipeline in the core 114. Optionally, the instruction group may a smaller number of instructions.

### Cascaded Delayed Execution Pipeline

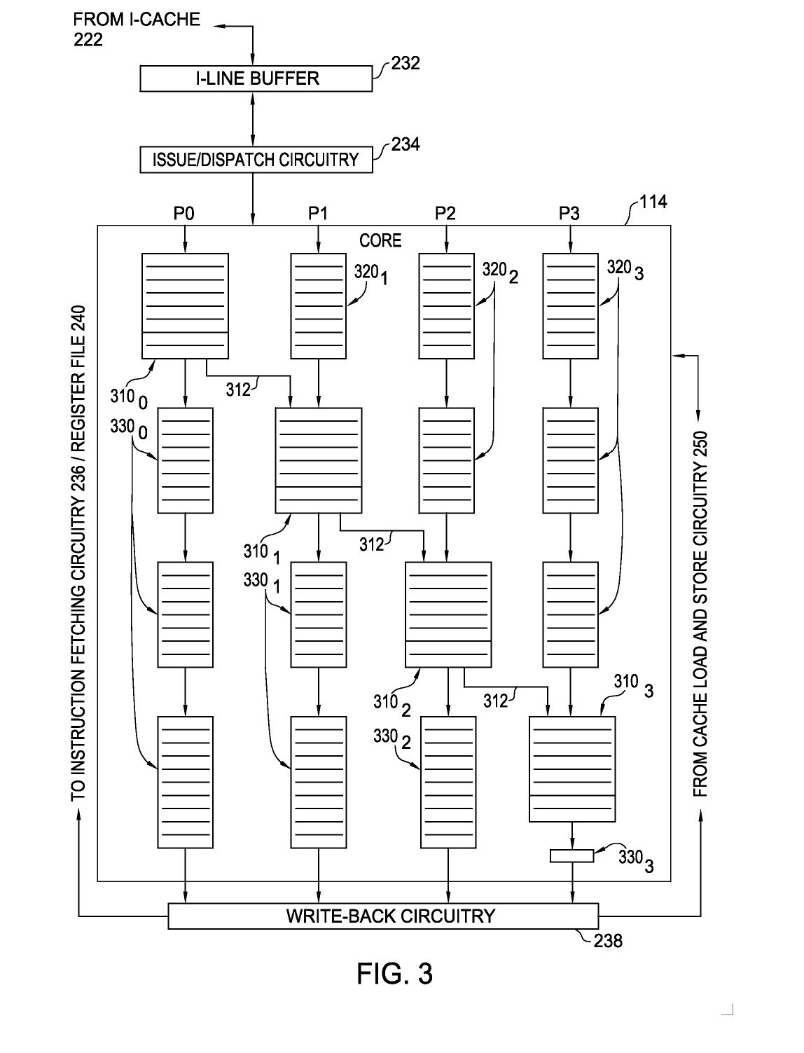

According to one embodiment of the invention, one or more processor cores 114 may utilize a cascaded, delayed execution pipeline configuration. In the example depicted in FIG. 3, the core 114 contains four pipelines in a cascaded configuration. Optionally, a smaller number (two or more pipelines) or a larger number (more than four pipelines) may be used in such a configuration. Furthermore, the physical layout of the pipeline depicted in FIG. 3 is exemplary, and not necessarily suggestive of an actual physical layout of the cascaded, delayed execution pipeline unit.

In one embodiment, each pipeline (P0, P1, P2, P3) in the cascaded, delayed execution pipeline configuration may contain an execution unit 310. The execution unit 310 may contain several pipeline stages which perform one or more functions for a given pipeline. For example, the execution unit 310 may perform all or a portion of the fetching and decoding of an instruction. The decoding performed by the execution unit may be shared with a predecoder and scheduler 220 which is shared among multiple cores 114 or, optionally, which is utilized by a single core 114. The execution unit may also read data from a register file, calculate addresses, perform integer arithmetic functions (e.g., using an arithmetic logic unit, or ALU), perform floating point arithmetic functions, execute instruction branches, perform data access functions (e.g., loads and stores from memory), and store data back to registers (e.g., in the register file 240). In some cases, the core 114 may utilize instruction fetching circuitry 236, the register file 240, cache load and store circuitry 250, and write-back circuitry, as well as any other circuitry, to perform these functions.

In one embodiment, each execution unit 310 may perform the same functions. Optionally, each execution unit 310 (or different groups of execution units) may perform different sets of functions. Also, in some cases the execution units 310 in each core 114 may be the same or different from execution units 310 provided in other cores. For example, in one core, execution units 310₀ and 310₂ may perform load/store and arithmetic functions while execution units 310₁ and 310₂ may perform only arithmetic functions.

In one embodiment, as depicted, execution in the execution units 310 may be performed in a delayed manner with respect to the other execution units 310. The depicted arrangement may also be referred to as a cascaded, delayed configuration, but the depicted layout is not necessarily indicative of an actual physical layout of the execution units. Instructions in a common issue group (e.g., instructions I0, I1, I2, and I3) may be issued in parallel to the pipelines P0, P1, P2, P3, with each instruction may be executed in a delayed fashion with respect to each other instruction. For example, instruction I0 may be executed first in the execution unit 310₀ for pipeline P0, instruction I1 may be executed second in the execution unit 310₁ for pipeline P1, and so on.

In such a configuration, where instructions in a group executed in parallel are not required to issue in program order (e.g., if no dependencies exist between instructions they may be issued to any pipe) all instruction groups are assumed to be executed in order for the previous examples. However, out of order execution across groups is also allowable for other exemplary embodiments. In out of order execution, the cascade delayed arrangement may still provide similar advantages. However, in some cases, it may be decided that one instruction from a previous group may not be executed with that group. As an example, a first group may have three loads (in program order: L1, L2, and L3), with L3 dependent on L1, and L2 not dependent on either. In this example, L1 and L3 may be issued in a common group (with L3 issued to a more delayed pipeline), while L2 may be issued “out of order” in a subsequent issue group.

In one embodiment, upon issuing the issue group to the processor core 114, I0 may be executed immediately in execution unit 310₀. Later, after instruction 10 has finished being executed in execution unit 310₀, execution unit 310₁ may begin executing instruction I1, and so on, such that the instructions issued in parallel to the core 114 are executed in a delayed manner with respect to each other.

In one embodiment, some execution units 310 may be delayed with respect to each other while other execution units 310 are not delayed with respect to each other. Where execution of a second instruction is dependent on the execution of a first instruction, forwarding paths 312 may be used to forward the result from the first instruction to the second instruction. The depicted forwarding paths 312 are merely exemplary, and the core 114 may contain more forwarding paths from different points in an execution unit 310 to other execution units 310 or to the same execution unit 310.

In one embodiment, instructions which are not being executed by an execution unit 310 (e.g., instructions being delayed) may be held in a delay queue 320 or a target delay queue 330. The delay queues 320 may be used to hold instructions in an instruction group which have not yet been executed by an execution unit 310. For example, while instruction I0 is being executed in execution unit 310₀, instructions I1, I2 and I3 may be held in a delay queue 330. Once the instructions have moved through the delay queues 330, the instructions may be issued to the appropriate execution unit 310 and executed. The target delay queues 330 may be used to hold the results of instructions which have already been executed by an execution unit 310. In some cases, results in the target delay queues 330 may be forwarded to executions units 310 for processing or invalidated where appropriate. Similarly, in some circumstances, instructions in the delay queue 320 may be invalidated, as described below.

In one embodiment, after each of the instructions in an instruction group have passed through the delay queues 320, execution units 310, and target delay queues 330, the results (e.g., data, and, as described below, instructions) may be written back either to the register file or the L1 I-cache 222 and/or D-cache 224. In some cases, the write-back circuitry 238 may be used to write back the most recently modified value of a register (received from one of the target delay queues 330) and discard invalidated results.

### Performance of Cascaded Delayed Execution Pipelines

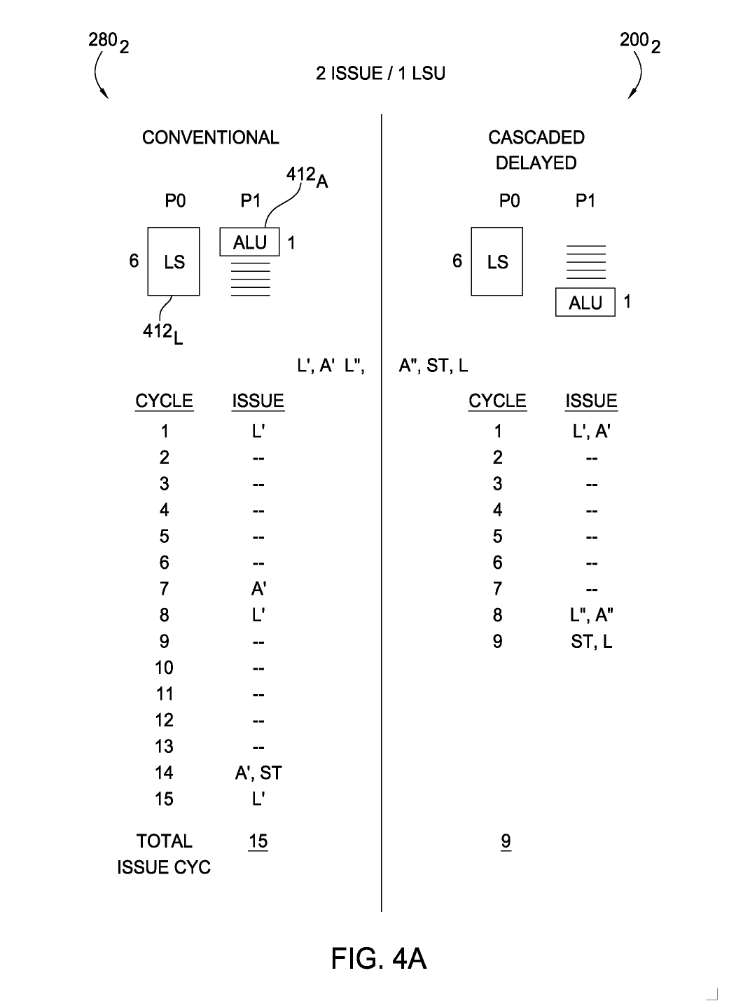

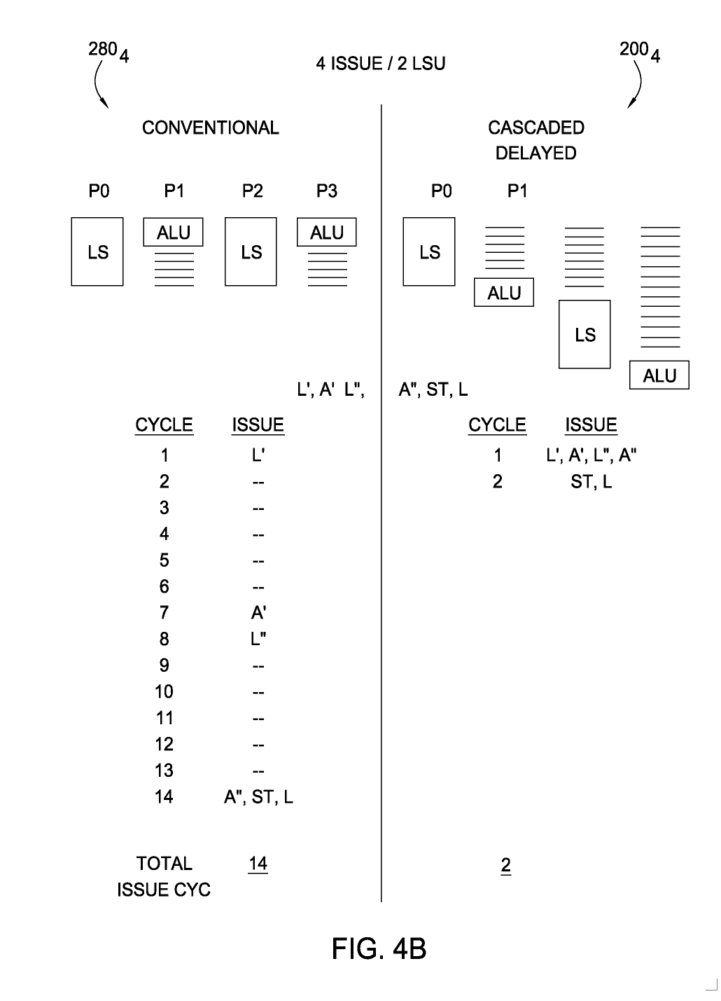

The performance impact of cascaded delayed execution pipelines may be illustrated by way of comparisons with conventional in-order execution pipelines, as shown in FIGS. 4A and 4B. In FIG. 4A, the performance of a conventional “2 issue” pipeline arrangement 2802 is compared with a cascaded-delayed pipeline arrangement 2002, in accordance with embodiments of the present invention. In FIG. 4B, the performance of a conventional “4 issue” pipeline arrangement 2804 is compared with a cascaded-delayed pipeline arrangement 2004, in accordance with embodiments of the present invention.

For illustrative purposes only, relatively simple arrangements including only load store units (LSUs) 412 and arithmetic logic units (ALUs) 414 are shown. However, those skilled in the art will appreciate that similar improvements in performance may be gained using cascaded delayed arrangements of various other types of execution units. Further, the performance of each arrangement will be discussed with respect to execution of an exemplary instruction issue group (L′-A′-L″-A″-ST-L) that includes two dependent load-add instruction pairs (L′-A′ and L″-A″), an independent store instruction (ST), and an independent load instruction (L). In this example, not only is each add dependent on the previous load, but the second load (L″) is dependent on the results of the first add (A′).

Referring first to the conventional 2-issue pipeline arrangement 2802 shown in FIG. 4A, the first load (L′) is issued in the first cycle. Because the first add (A′) is dependent on the results of the first load, the first add cannot issue until the results are available, at cycle 7 in this example. Assuming the first add completes in one cycle, the second load (L″), dependent on its results, can issue in the next cycle. Again, the second add (A″) cannot issue until the results of the second load are available, at cycle 14 in this example. Because the store instruction is independent, it may issue in the same cycle. Further, because the third load instruction (L) is independent, it may issue in the next cycle (cycle 15), for a total of 15 issue cycles.

Referring next to the 2-issue delayed execution pipeline 2002 shown in FIG. 4A, the total number of issue cycles may be significantly reduced. As illustrated, due to the delayed arrangement, with an arithmetic logic unit (ALU) 412_{A} of the second pipeline (P1) located deep in the pipeline relative to a load store unit (LSU) 412_{L} of the first pipeline (P0), both the first load and add instructions (L′-A′) may be issued together, despite the dependency. In other words, by the time A′ reaches ALU 412_{A}, the results of the L′ may be available and forwarded for use in execution of A′, at cycle 7. Again assuming A′ completes in one cycle, L″ and A″ can issue in the next cycle. Because the following store and load instructions are independent, they may issue in the next cycle. Thus, even without increasing the issue width, a cascaded delayed execution pipeline 2002 reduces the total number of issue cycles to 9.

Referring next to the conventional 4-issue pipeline arrangement 2804 shown in FIG. 4B, it can be seen that, despite the increase (×2) in issue width, the first add (A′) still cannot issue until the results of the first load (L′) are available, at cycle 7. After the results of the second load (L″) are available, however, the increase in issue width does allow the second add (A″) and the independent store and load instructions (ST and L) to be issued in the same cycle. However, this results in only marginal performance increase, reducing the total number of issue cycles to 14.

Referring next to the 4-issue cascaded delayed execution pipeline 2004 shown in FIG. 4B, the total number of issue cycles may be significantly reduced when combining a wider issue group with a cascaded delayed arrangement. As illustrated, due to the delayed arrangement, with a second arithmetic logic unit (ALU) 412_{A} of the fourth pipeline (P3) located deep in the pipeline relative to a second load store unit (LSU) 412_{L} of the third pipeline (P2), both load add pairs (L′-A′ and L″-A″) may be issued together, despite the dependency. In other words, by the time L″ reaches LSU 412L of the third pipeline (P2), the results of A′ will be available and by the time A″ reaches ALU 412_{A} of the fourth pipeline (P3), the results of A″ will be available. As a result, the subsequent store and load instructions may issue in the next cycle, reducing the total number of issue cycles to 2.

### Scheduling Instructions in an Issue Group

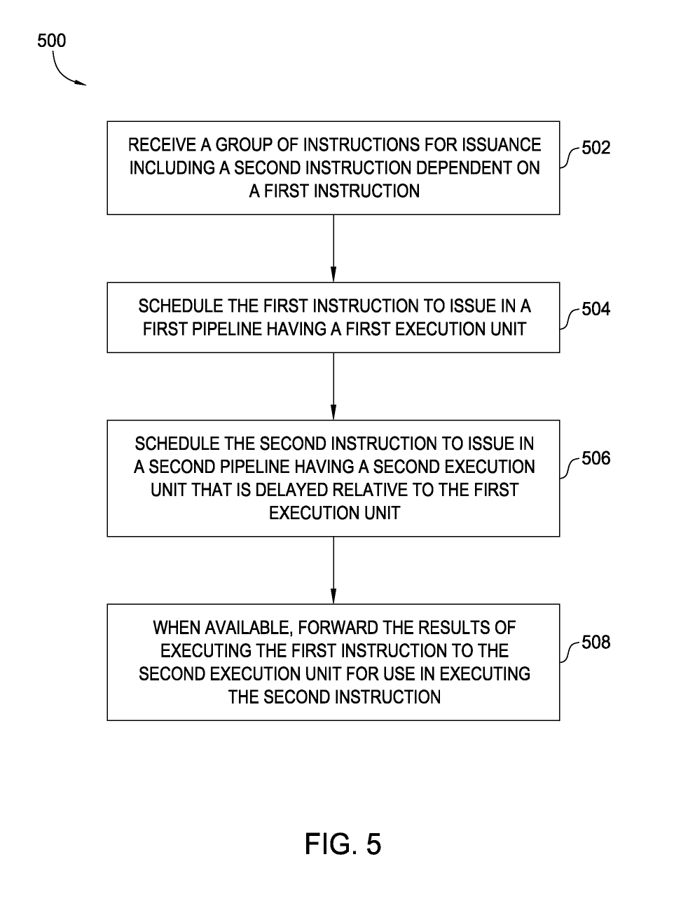

FIG. 5 illustrates exemplary operations 500 for scheduling and issuing instructions with at least some dependencies for execution in a cascaded-delayed execution pipeline. For some embodiments, the actual scheduling operations may be performed in a predecoder/scheduler circuit shared between multiple processor cores (each having a cascaded-delayed execution pipeline unit), while dispatching/issuing instructions may be performed by separate circuitry within a processor core. As an example, a shared predecoder/scheduler may apply a set of scheduling rules by examining a “window” of instructions to issue to check for dependencies and generate a set of “issue flags” that control how (to which pipelines) dispatch circuitry will issue instructions within a group.

In any case, at step 502, a group of instructions to be issued is received, with the group including a second instruction dependent on a first instruction. At step 504, the first instruction is scheduled to issue in a first pipeline having a first execution unit. At step 506, the second instruction is scheduled to issue in a second pipeline having a second execution unit that is delayed relative to the first execution unit. At step 508 (during execution), the results of executing the first instruction are forwarded to the second execution unit for use in executing the second instruction.

The exact manner in which instructions are scheduled to different pipelines may vary with different embodiments and may depend, at least in part, on the exact configuration of the corresponding cascaded-delayed pipeline unit. As an example, a wider issue pipeline unit may allow more instructions to be issued in parallel and offer more choices for scheduling, while a deeper pipeline unit may allow more dependent instructions to be issued together.

Of course, the overall increase in performance gained by utilizing a cascaded-delayed pipeline arrangement will depend on a number of factors. As an example, wider issue width (more pipelines) cascaded arrangements may allow larger issue groups and, in general, more dependent instructions to be issued together. Due to practical limitations, such as power or space costs, however, it may be desirable to limit the issue width of a pipeline unit to a manageable number. For some embodiments, a cascaded arrangement of 4-6 pipelines may provide good performance at an acceptable cost. The overall width may also depend on the type of instructions that are anticipated, which will likely determine the particular execution units in the arrangement.

### An Example Embodiment of an Integer Cascaded Delayed Execution Pipeline

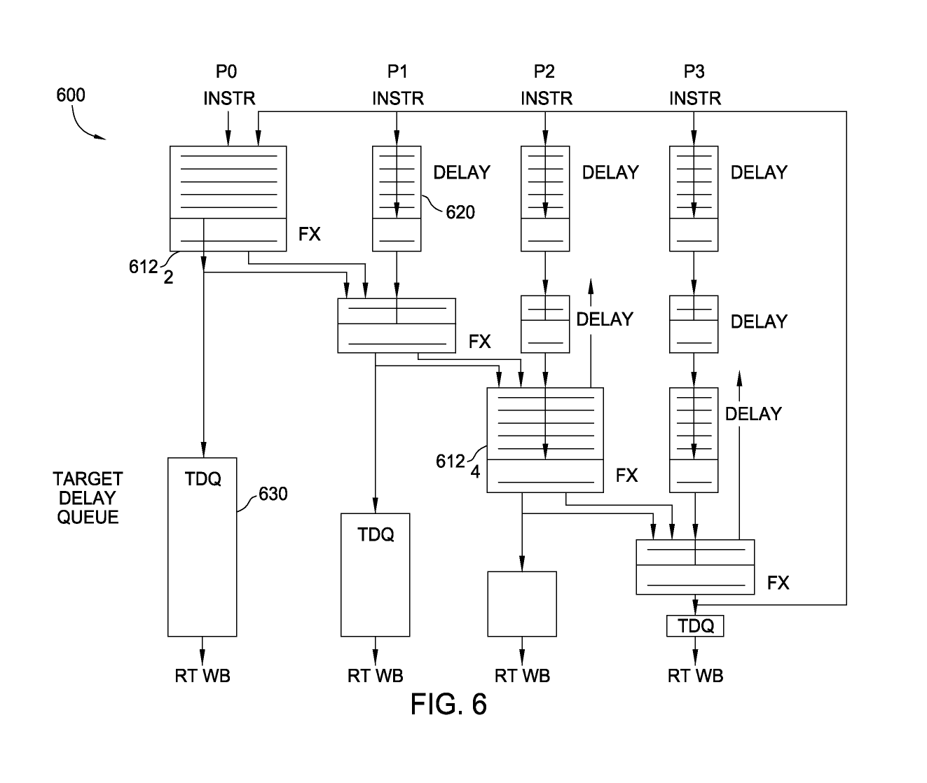

FIG. 6 illustrates an exemplary arrangement of a cascaded-delayed execution pipeline unit 600 for executing integer instructions. As illustrated, the unit has four execution units, including two LSUs 612_{L} and two ALUs 614_{A}. The unit 600 allows direct forwarding of results between adjacent pipelines. For some embodiments, more complex forwarding may be allowed, for example, with direct forwarding between non-adjacent pipelines. For some embodiments, selective forwarding from the target delay queues (TDQs) 630 may also be permitted.

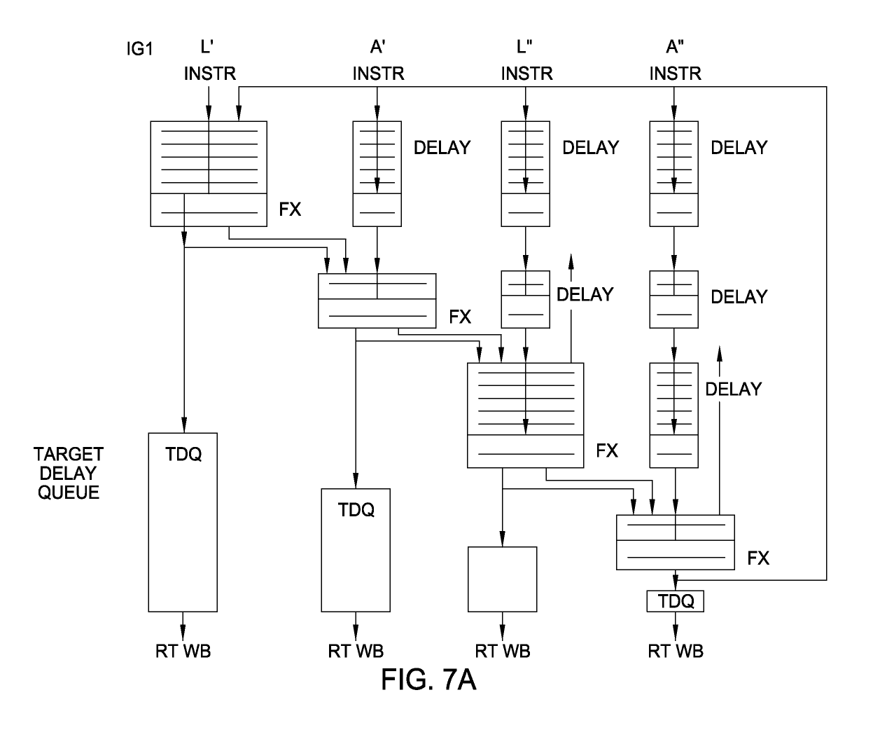

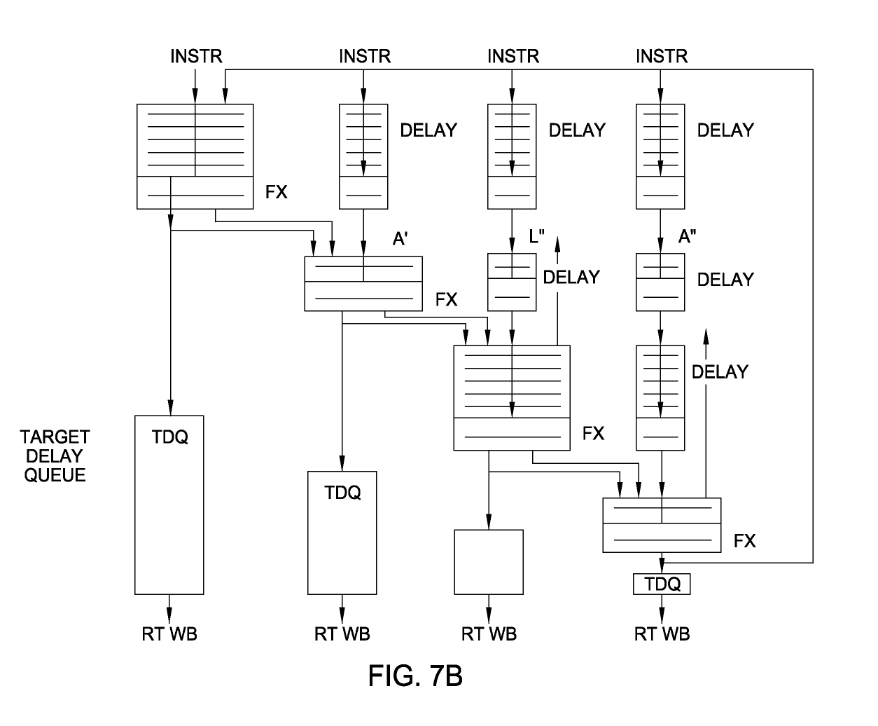

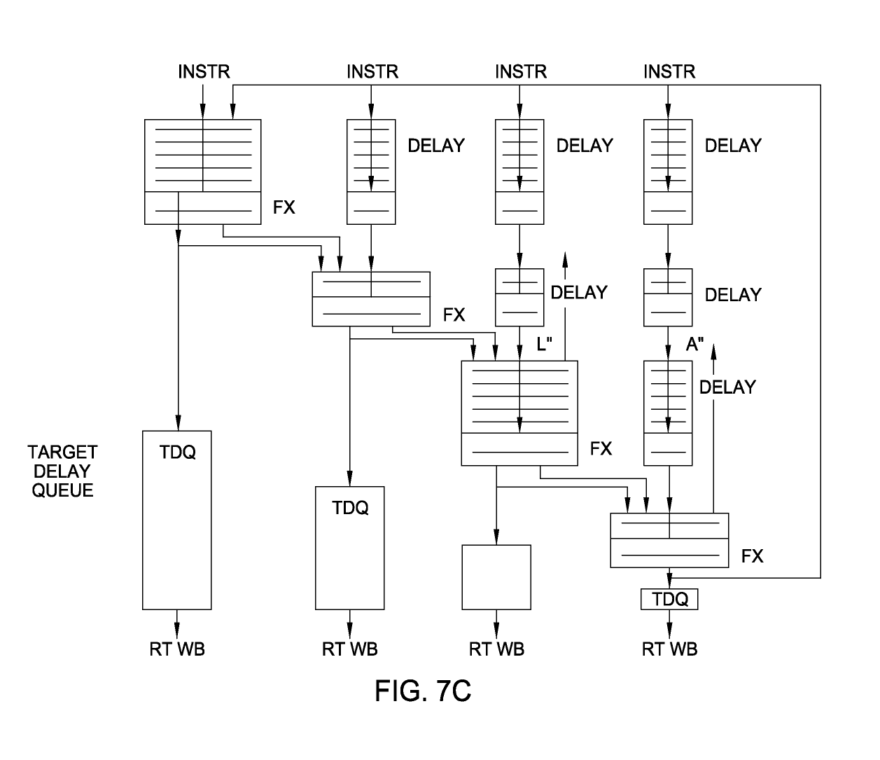

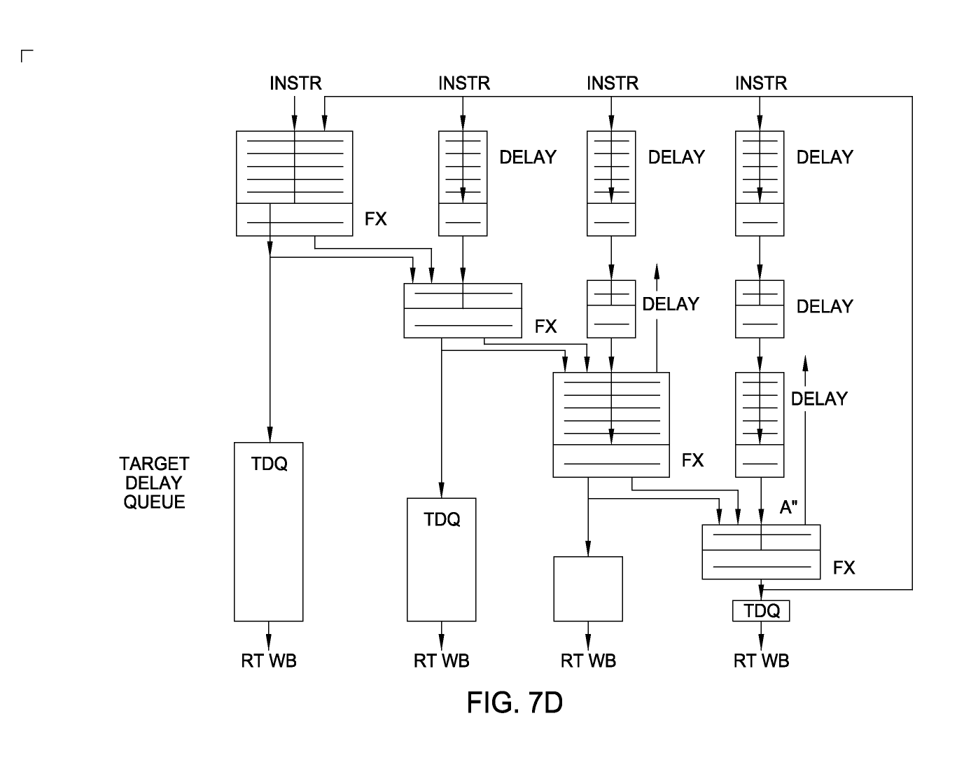

FIGS. 7A-7D illustrate the flow of an exemplary issue group of four instructions (L′-A′-L″-A″) through the pipeline unit 600 shown in FIG. 6. As illustrated, in FIG. 7A, the issue group may enter the unit 600, with the first load instruction (L′) scheduled to the least delayed first pipeline (P0). As a result, L′ will reach the first LSU 612L to be executed before the other instructions in the group (these other instructions may make there way down through instruction queues 620) as L′ is being executed.

As illustrated in FIG. 7B, the results of executing the first load (L′) may be available (just in time) as the first add A′ reaches the first ALU 612A of the second pipeline (P1). In some cases, the second load may be dependent on the results of the first add instruction, for example, which may calculate by adding an offset (e.g., loaded with the first load L′) to a base address (e.g., an operand of the first add A′).

In any case, as illustrated in FIG. 7C, the results of executing the first add (A′) may be available as the second load L″ reaches the second LSU 612L of the third pipeline (P2). Finally, as illustrated in FIG. 7D, the results of executing the second load (L″) may be available as the second add A″ reaches the second ALU 612A of the fourth pipeline (P3). Results of executing instructions in the first group may be used as operands in executing the subsequent issue groups and may, therefore, be fed back (e.g., directly or via TDQs 630).

While not illustrated, it should be understood that each clock cycle a new issue groups may enter the pipeline unit 600. In some cases, for example, due to relatively rare instruction streams with multiple dependencies (L′-L″-L′″), each new issue group may not contain a maximum number of instructions (4 in this example), the cascaded delayed arrangement described herein may still provide significant improvements in throughput by allowing dependent instructions to be issued in a common issue group without stalls.

### Compound Instruction Group Formation and Execution

As in the case of a cascaded-delayed execution pipeline described above, a set of instructions may be issued as a group (an issue group) to a pipelined execution unit that operates on the instructions in parallel. Challenges are presented, however, when conditional branch instructions target instructions outside a current instruction line (I-line).

For example, instructions in the execution stream may be processed (before the condition can be resolved) based on a prediction that the branch will not be taken, allowing execution to continue within the I-line, yielding increased performance if the prediction is correct. However, if the prediction is not correct, the I-line containing the instructions to be executed if the branch is taken must be fetched with substantial latency penalty, and the processing cycles spent executing the branch not taken instructions are wasted.

Embodiments of the present invention, may allow for efficient execution of an instruction stream, even if the stream includes a branch to a different I-line. For some embodiments, I-lines containing instructions targeted by predicted conditional branches may be automatically pre-fetched from the L2 cache into the instruction cache (I-cache). During issue group formation, a “compound” issue group of instructions may be formed that contains instructions from both the I-line containing the branch as well as the pre-fetched I-line containing the instructions to be executed if the branch is taken.

For some embodiments, during prefetch operations, an instruction line being fetched may be examined for “exit branch instructions” that branch to (target) instructions that lie outside the instruction line. The target address of these exit branch instructions may be extracted and used to prefetch, from L2 cache, the instruction line containing the targeted instruction. As a result, if/when the exit branch is taken, the targeted instruction line may already be in the L1 instruction cache (“I-cache”), thereby avoiding a costly miss in the I-cache and improving overall performance. Examples of such pre-fetching operations are described in commonly-owned U.S. patent application Ser. No. 11/347,412, herein incorporated by reference in its entirety.

For some embodiments, prefetch data may be stored in a traditional cache memory in the corresponding block of information (e.g., instruction line or data line) to which the prefetch data pertains. As the corresponding block of information is fetched from the cache memory, the block of information may be examined and used to prefetch other, related blocks of information. Prefetches may then be performed using prefetch data stored in each other prefetched block of information. By using information within a fetched block of information to prefetch other blocks of information related to the fetched block of information, cache misses associated with the fetched block of information may be prevented.

These prefetched I-lines allow for compound issue group formation during instruction group scheduling. For example, during scheduling, the compound issue group may be formed during a sequential instruction fetch operation (when a predicted branch condition is reached) by merging a prefetched target instruction register (TIR) with a sequential instruction register (IR) under control of stop bits.

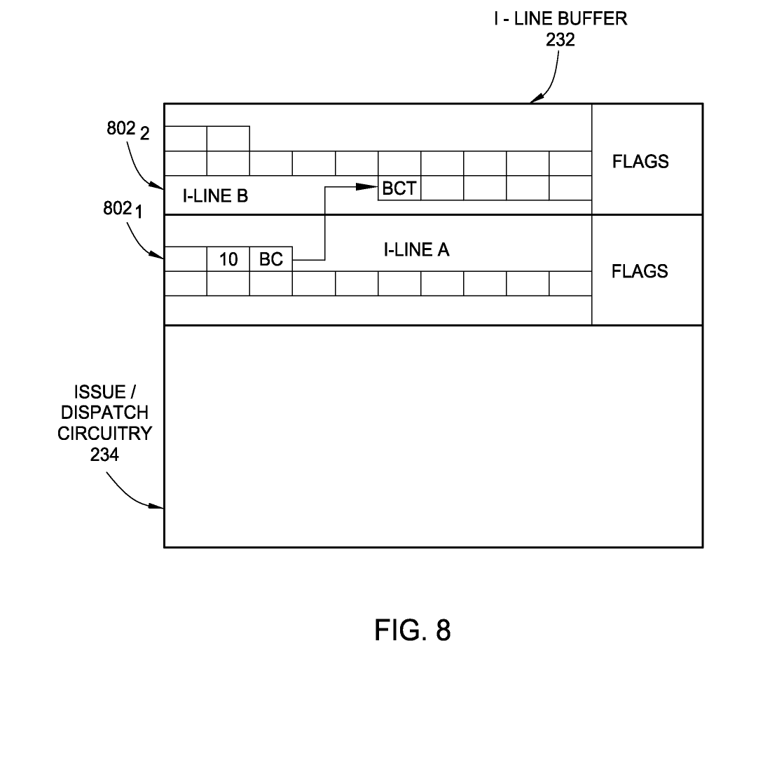

FIG. 8 illustrates an example of an instruction line buffer 232 with multiple I-lines 802 that may be prefetched as described above, and associated issue and dispatch circuitry 834. Within I-line A 802₁ there may be several sequential instructions, including a branch conditional instruction. The branch conditional instruction may point to an instruction within the currently selected I-line, or it may point to an instruction within a separate I-line. Within I-line B 802₂ there may be many instructions including an instruction that is the target, or branch conditional target BCT, of the branch conditional instruction found in I-line A 802₁.

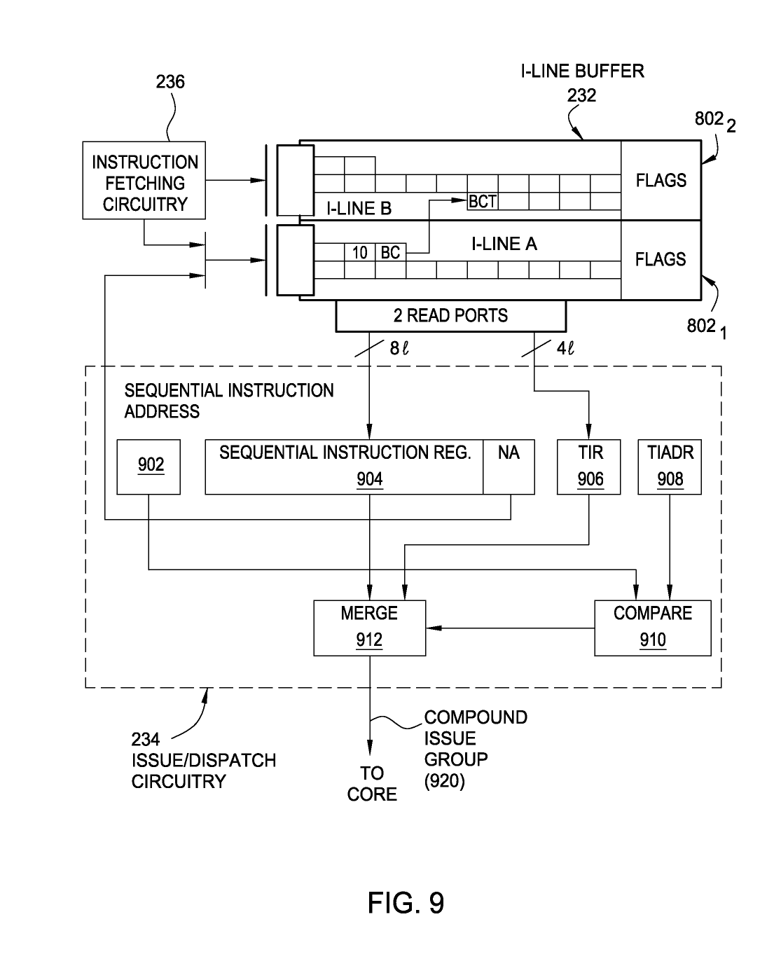

FIG. 9 shows an embodiment of an I-line buffer and the corresponding issue and dispatch circuitry 234 in greater detail. The instruction fetching circuitry 236 controls the selection of instruction lines from I-lines 802₁ and 802₂ in the I-line buffer to be used in forming a compound issue group. As an example, the instruction fetching circuitry may generate control signals to select instructions from a sequential instruction stream to be loaded in a sequential instruction register 904 or in the target instruction register 906.

In some cases, all of the needed instructions for an issue group may be present sequentially in a single I-line. In such cases, those instructions are taken from the sequential instruction register, passed uninterrupted through the merge element 912, and outputted as an issue group 920.

However, in response to scheduling flags, for example, that indicate prediction that a branch will be taken to a target location outside of an I-line, the circuitry 236 may merge instructions from registers 904 and 906 into an issue group buffer 912 to form issue groups of instructions 920.

Such a merger may be performed, when a sequential I-fetch reaches a predicted conditional branch instruction. This may be determined by a comparison 910 between the sequential instruction address stored in element 902 and the target instruction address stored in element 908. When the element 902 equals element 604 during execution, the prefetched target instruction register 906 may be merged with the sequential instruction register 904 under the control of stop bits. The result of this merge is a compound issue group 920 that is sent to the core 114.

An example compound issue group 920 is illustrated in FIG. 10. As shown, the compound issue group 920 may include a sequential stream of instructions from I-line A before the branch conditional instructions and from I-line B after the branch is taken. As described above, this compound issue group may be dispatched to a processing core with a set of cascaded-delayed pipelines, allowing instructions from multiple I-lines to be efficiently processed with reduced delay.

While embodiments of the present invention have been described with reference to cascaded-delayed execution pipelines, those skilled in the art will recognize that compound issue groups may also be formed and dispatched to other types of pipelined execution units.

### CONCLUSION

By providing a “cascade” of execution pipelines that are delayed relative to each other, a set of dependent instructions in an issue group may be intelligently scheduled to execute in different delayed pipelines such that the entire issue group can execute without stalls. In addition, by prefetching instruction lines containing instructions targeted by a conditional branch statement, if it is predicted that the conditional branch will be taken, a compound issue group may be formed with instructions from the I-line containing the branch statement and the I-line containing instructions targeted by the branch.

While the foregoing is directed to embodiments of the present invention, other and further embodiments of the invention may be devised without departing from the basic scope thereof, and the scope thereof is determined by the claims that follow

What is claimed is:

1. A method of forming a compound issue group of instructions, comprising:
fetching a first instruction line from a level 2 cache, the first instruction line having a branch instruction targeting an instruction that is outside of the first instruction line;
prefetching, from the level 2 cache, a second instruction line containing the targeted instruction;
forming a compound issue group containing a sequential stream of instructions including instructions from the first instruction line prior to the branch instruction and at least the targeted instruction from the second instruction line; and
issuing the compound issue group to a pipelined execution unit for execution.

2. The method of claim 1, wherein forming the compound issue group comprises:
merging a first buffered sequential stream of instructions from the first cache line with a second buffered sequential stream of instructions from the second cache line.

3. The method of claim 1, wherein forming the compound issue group comprises:
comparing a sequential instruction address and a target instruction address.

4. The method of claim 3, wherein forming the compound issue group further comprises:
based on the comparison, merging a first set of instructions from the first instruction line in a sequential instruction buffer with a second set of instructions from the second instruction line in a target instruction buffer.

5. The method of claim 1, further comprising:
extracting an address from the branch instruction; and
using the extracted address in pre-fetching the second instruction line.

6. The method of claim 1, wherein issuing the compound issue group to a pipelined execution unit for execution comprises:
determining if a second instruction in the compound issue group is dependent on results generated by executing a first instruction in the compound issue group; and
if so, scheduling the first instruction for execution in a first pipeline and scheduling the second instruction for execution in a second pipeline in which execution of the second instruction is delayed with respect to execution of the first instruction in the first pipeline.

7. The method of claim 1, further comprising:
storing a history bit in the first cache line indicating whether or not a branch associated with the branch instruction was taken.

8. A processor comprising:
a level 2 cache;
a level 1 cache configured to receive instruction lines from the level 2 cache, wherein each instruction line comprises one or more instructions;
a processor core configured to execute instructions retrieved from the level 1 cache; and
scheduling circuitry configured to:
fetch a first instruction line from a level 2 cache, the first instruction line having a branch instruction targeting an instruction that is outside of the first instruction line;
prefetch, from the level 2 cache, a second instruction line containing the targeted instruction;
form a compound issue group containing a sequential stream of instructions including instructions from the first instruction line prior to the branch instruction and at least the targeted instruction from the second instruction line, and
issue the compound issue group to a pipelined execution unit for execution.

9. The processor of claim 8, wherein the scheduling circuitry is configured to form the compound issue group by:
merging a first buffered sequential stream of instructions from the first cache line with a second buffered sequential stream of instructions from the second cache line.

10. The processor of claim 8, wherein the scheduling circuitry is configured to form the compound issue group by:
comparing a sequential instruction address and a target instruction address.

11. The processor of claim 10, wherein the scheduling circuitry is configured to form the compound issue group by:
based on the comparison, merging a first set of instructions from the first instruction line in a sequential instruction buffer with a second set of instructions from the second instruction line in a target instruction buffer.

12. The processor of claim 8, wherein the scheduling circuitry is further configured to:
extract an address from the branch instruction; and
use the extracted address in pre-fetching the second instruction line.

13. The processor of claim 8, further comprising dispatch circuitry configured to:
determine if a second instruction in the compound issue group is dependent on results generated by executing a first instruction in the compound issue group; and
if so, dispatch the first instruction for execution in a first pipeline and scheduling the second instruction for execution in a second pipeline in which execution of the second instruction is delayed with respect to execution of the first instruction in the first pipeline.

14. The processor of claim 8, further comprising:
circuitry configured to store a history bit in the first cache line indicating whether or not a branch associated with the branch instruction was taken.

15. An integrated circuit device comprising:
a cascaded delayed execution pipeline unit having at least first and second execution pipelines, wherein instructions in a common issue group issued to the execution pipeline unit are executed in the first execution pipeline before the second execution pipeline; and
scheduling circuitry configured to prefetch first and second cache lines of instructions, form an issue group having a sequential stream of one or more instructions in the first cache line before a branch instruction and one or more instructions in the second cache line targeted by the branch instruction, determine if a second instruction in the issue group is dependent on results generated by executing a first instruction in the issue group and, if so, schedule the first instruction for execution in the first execution pipeline and schedule the second instruction for execution in the second execution pipeline.

16. The device of claim 15, wherein the scheduling circuitry is configured to form the compound issue group by:
comparing a sequential instruction address and a target instruction address.

17. The device of claim 16, wherein the scheduling circuitry is configured to form the compound issue group by:
based on the comparison, merging a first set of instructions from the first instruction line in a sequential instruction buffer with a second set of instructions from the second instruction line in a target instruction buffer.

18. The device of claim 15, wherein the scheduling circuitry determines if the second instruction is dependent on the first instruction by examining source and target operands of the first and second instructions.

19. The device of claim 15, wherein the cascaded delayed execution pipeline unit has at least third and fourth execution pipelines, wherein instructions in a common issue group issued to the execution pipeline unit are executed in the first, second, and third execution pipelines before the fourth execution pipelines.

20. The device of claim 15, wherein the first and second execution units execute instructions that operate on integer values.
